(19) United States
(12) Patent Application Publication
(10) Pub. No.: US 2026/0077389 A1
(43) Pub. Date: Mar. 19, 2026

(54) SORTING MODULE AND SORTING DEVICE

(71) Applicant: Shenzhen Luhui Logistics Equipments Co. Ltd, Shenzhen (CN)

(72) Inventors: Fengcheng CAO, Shenzhen (CN); Jinghui HU, Shenzhen (CN); Hui MENG, Shenzhen (CN)

(73) Assignee: Shenzhen Luhui Logistics Equipments Co. Ltd, Shenzhen (CN)

(21) Appl. No.: 19/401,288

(22) Filed: Nov. 25, 2025

Related U.S. Application Data
(63) Continuation of application No. PCT/CN2024/090865, filed on Apr. 30, 2024.

(30) Foreign Application Priority Data
Jun. 29, 2023 (CN) 202310794287.9

(51) Int. Cl. B07C 3/02; B65G 13/06; B65G 13/11; B65G 39/02

(52) U.S. Cl. CPC B07C 3/02; B65G 13/06; B65G 13/11; B65G 39/02

(57) ABSTRACT

A sorting module includes a sorting support, a mounting port, a transmission mechanism and a limiting structure. The sorting support includes a bottom plate and two side plates provided on opposite sides of the bottom plate. The mounting ports are respectively provided at the two side plates, and the mounting ports include a first mounting port and a second mounting port communicated with each other. The transmission mechanism includes a shaft rod mounted on the first mounting port, and the shaft rod is fixed relative to the first mounting port. The first mounting port has a first direction for inserting the shaft rod, and the shaft rod abuts against and limits the opposite side walls of the first mounting port in a second direction. The limiting structure is provided at the second mounting port to abut against and limit the shaft rod in the first direction.

### CROSS-REFERENCE TO RELATED APPLICATIONS

This application is a continuation application of International Application No. PCT/CN2024/090865, filed on April 30, 2024, which claims priority to Chinese Patent Application No. 202310794287.9, filed on June 29, 2023. The disclosures of the above-mentioned applications are incorporated herein by reference in their entireties.

### TECHNICAL FIELD

The present application relates to the technical field of logistics sorting, and in particular to a sorting module and a sorting device.

### BACKGROUND

At present, sorting supports on the market are designed in a simplified and convenient manner, with a general “U” shape. The transmission mechanism usually includes a shaft rod and a gear sleeved on the shaft rod. When mounting the transmission mechanism into the sorting support, the gear is usually mounted on the shaft rod first, and then the entire shaft is inserted into the sorting support from top to bottom. There are through holes on the side plate of the sorting support. The two ends of the shaft are aligned with the through hole, and then the shaft is fixedly screwed into the sorting support by screwing screws.

However, in this connection method, the aperture of the through hole is usually provided to be larger than the diameter of the screw. After the shaft rod and the sorting support are fixed, the positions of the screws at both ends of the shaft rod in the through hole will change, and the connection between the shaft rod and the sorting support will be unstable, resulting in the axis of the shaft rod and the side plate not being perpendicular, thereby making the shaft rods of the two adjacent transmission mechanisms non-parallel, resulting in the teeth of the adjacent transmission gears mounted on the shaft rods not being aligned when meshing with each other, that is, the meshing gears are not in the same plane, and an abnormal meshing situation of “trapezoidal meshing” occurs during meshing, which affects the service life of the gears.

### SUMMARY

The main purpose of the present application is to provide a sorting module, aiming to ensure the stability of the connection between the shaft rod and the sorting support.

In order to achieve the above purpose, the present application provides a sorting module for a sorting device, including:

a sorting support including a bottom plate and two side plates provided at opposite sides of the bottom plate;

a mounting port respectively provided at the two side plates, wherein the mounting port includes a first mounting port and a second mounting port communicated with the first mounting port;

a transmission mechanism including a shaft rod mounted on the first mounting port, wherein the shaft rod is fixed relative to the first mounting port, the first mounting port is provided with a first direction for inserting the shaft rod, and the shaft rod abuts against and limits opposite side walls of the first mounting port in a second direction; and

a limiting structure provided in the second mounting port and configured to abut against and limit the shaft rod in the first direction;

wherein the first direction crosses the second direction.

In an embodiment, the shaft rod includes a main body portion and a protrusion protruding outward from two ends of the main body portion, and a first step surface located on an end surface of the main body portion is formed between the main body portion and the protrusion; and the protrusion is provided at the first mounting port, and the first step surface abuts against an inner wall surface of the side plate.

In an embodiment, an end surface of the protrusion is aligned with an outer wall surface of the side plate.

In an embodiment, the first mounting port includes an insertion port and a limiting port communicated with the insertion port, the insertion port is configured to allow the protrusion to be inserted into the limiting port, and the second mounting port passes through two opposite side walls of the insertion port.

In an embodiment, in the first direction, a height of the insertion port is greater than a height of the limiting port.

In an embodiment, in a direction perpendicular to the first direction, a distance between two side walls of the insertion port is greater than a diameter of the shaft rod.

In an embodiment, in an axial direction of the shaft rod, a cross-sectional area of the insertion port is 1 to 3 times a cross-sectional area of the limiting port.

In an embodiment, in the first direction, a height of the second mounting port is smaller than a height of the limiting port.

In an embodiment, the second mounting port extends along the second direction, and in the second direction, a length of the second mounting port is greater than a width of the insertion port and a width of the limiting port.

In an embodiment, a second step surface is further formed between the main body portion and the protrusion, the first mounting port is provided with a bottom wall downstream in the first direction, and the second step surface is located on a side of the protrusion away from the bottom wall; and a maximum distance from the second step surface to an end surface of the protrusion is greater than a maximum distance from the first step surface to the end surface of the protrusion.

In an embodiment, the limiting structure includes a connecting portion and a limiting portion connected to an end of the connecting portion, the limiting portion extends into the second mounting port and abuts against an outer wall surface of the protrusion and an inner wall surface of the second mounting port, respectively, and the connecting portion is configured to connect with the protrusion.

In an embodiment, the outer end surface of the protrusion is provided with a screw hole, the connecting portion is provided with a through hole for the screw to pass through, and the screw passes through the through hole and is screwed into the screw hole.

In an embodiment, a length of the limiting portion extending into the second mounting port is greater than a thickness of the side plate.

In an embodiment, an end portion of the protrusion is chamfered corresponding to a connection between the limiting portion and the connecting portion.

In an embodiment, an angle formed by the first direction and the second direction is in a range of 45° to 135°.

In an embodiment, the first direction is perpendicular to the second direction.

In an embodiment, the first mounting port extends along a vertical direction, and the second mounting port extends along a horizontal direction.

In an embodiment, the protrusion is formed by partially protruding outward from a middle portion of the end surface of the main body portion.

In an embodiment, in a radial direction of the shaft rod, a cross section of the protrusion is square.

In an embodiment, the transmission mechanism further includes a transmission gear, the sorting module further includes a roller group, and the transmission gear is rotatably provided at the shaft rod; and the roller group is provided at the sorting support, the roller group is provided with a roller gear, and the transmission gear meshes with the roller gear.

In an embodiment, the transmission mechanism further includes a bearing, and the bearing includes a bearing inner ring, a bearing outer ring, and a bearing ball located between the bearing inner ring and the bearing outer ring; and the bearing inner ring is sleeved on the shaft rod and fixed relative to the shaft rod, and the bearing outer ring is connected to the transmission gear.

In an embodiment, the sorting module further includes a base, and the sorting support is rotatably mounted on the base, and the base is configured to be fixedly connected to a machine platform of the sorting device.

The present application also provides a sorting module for a sorting device, including:

a sorting support including a bottom plate and two side plates provided at opposite sides of the bottom plate;

a mounting port provided at the two side plates, wherein the mounting ports includes a first mounting port and a second mounting port communicated with the first mounting port, the first mounting port extends along a vertical direction, and the second mounting port extends along a horizontal direction;

a transmission mechanism including a shaft rod, a bearing and a transmission gear, wherein the bearing is sleeved on the shaft rod, and the transmission gear is sleeved on the bearing; the shaft rod includes a main body portion and a protrusion formed by partially protruding outward from the middle portion of the end surfaces of both ends of the main body portion; the first mounting port includes an insertion port and a square limiting port communicated with the insertion port, the square limiting port is located below the insertion port, the insertion port is configured to allow the protrusion to be inserted into the square limiting port, and the square limiting port clamps and limits the protrusion in a horizontal direction; a first step surface is formed between the main body portion and the protrusion on an end surface of the main body portion, and the first step surface abuts against an inner wall surface of the side plate;

a limiting structure is provided at the second mounting port and configured to abut against and limit a position of the shaft rod in the vertical direction; and

a roller group is provided at the sorting support, the roller group is provided with a roller gear, and the transmission gear meshes with the roller gear.

In an embodiment, the second mounting port passes through two opposite side walls of the insertion port; in the vertical direction, a height of the insertion port is greater than a height of the square limiting port, and a height of the second mounting port is less than the height of the square limiting port; and in the horizontal direction, a distance between the two side walls of the insertion port is greater than a diameter of the shaft rod.

In an embodiment, a second step surface is further formed between the main body portion and the protrusion, and the second step surface is located on a side of the protrusion away from a bottom of the first mounting port; and a maximum distance from the second step surface to an end surface of the protrusion is greater than a maximum distance from the first step surface to the end surface of the protrusion.

In an embodiment, the limiting structure includes a connecting portion and a limiting portion connected to an end of the connecting portion, the limiting portion extends into the second mounting port and abuts against an outer wall surface of the protrusion and an inner wall surface of the second mounting port, respectively, and the connecting portion is configured to connect with the protrusion; a length of the limiting portion extending into the second mounting port is greater than a thickness of the side plate; and the end of the protrusion is chamfered corresponding to a connection between the limiting portion and the connecting portion, and the end surface of the protrusion is aligned with an outer wall surface of the side plate.

The present application also provides a sorting device, and the sorting device includes the sorting module as described above.

In the technical solution of the present application, by limiting the shaft rod mounted in the first mounting port through the two opposing side walls of the first mounting port and the limiting structure in the intersecting first direction and second direction, the position of the shaft rod mounted in the first mounting port is fixed, so that the shaft rod will not be displaced relative to the sorting support, ensuring the stability of the connection between the shaft rod and the sorting support. This avoids the abnormal meshing situation of “trapezoidal meshing” that occurs when the transmission gears mounted on two adjacent shaft rods are not aligned during meshing, i.e., the meshing gears are not on the same plane, thus ensuring the service life of the gears.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a sorting module of according to an embodiment of present application.

FIG. 2 is an exploded view of a partial structure of the structure in FIG. 1.

FIG. 3 is an enlarged view of point A in FIG. 2.

FIG. 4 is a schematic structural view of a sorting support in FIG. 1.

FIG. 5 is an enlarged view of point B in FIG. 4.

FIG. 6 is a top view of the sorting module in FIG. 1.

FIG. 7 is a cross-sectional view along line I-I in FIG. 6.

FIG. 8 is an enlarged view of point C in FIG. 7.

FIG. 9 is a cross-sectional view along line K-K in FIG. 6.

FIG. 10 is a schematic structural diagram of the shaft in FIG. 1.

The achievement of the objectives, functional features, and advantages of the present application will be further explained with reference to the embodiments and accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicating the number of technical features indicated. Thus, a feature delimited with “first”, “second” may expressly or implicitly include at least one of these features. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of the present application.

The present application provides an embodiment of a sorting module, and the sorting module is mainly used for a sorting device. The sorting device is a sorting equipment commonly used in existing logistics and transportation, which mainly includes a sorting module and a platform assembly. The goods are transported by the rotation of the roller group on the sorting module, and the overall rotation of the sorting module controls the direction of transport, thereby achieving the purpose of sorting the goods. There are usually a plurality of sorting modules in the sorting device, and the plurality of sorting modules are provided in an array. The sorting module includes a sorting support and a base, the base is configured to be fixedly connected to the frame of the sorting device, and the sorting support is mounted on the base and is rotatable relative to the base. The transmission mechanism is mounted inside the sorting support and the base, and the roller group is mounted on the sorting support and is connected to the transmission mechanism so that the roller group can rotate.

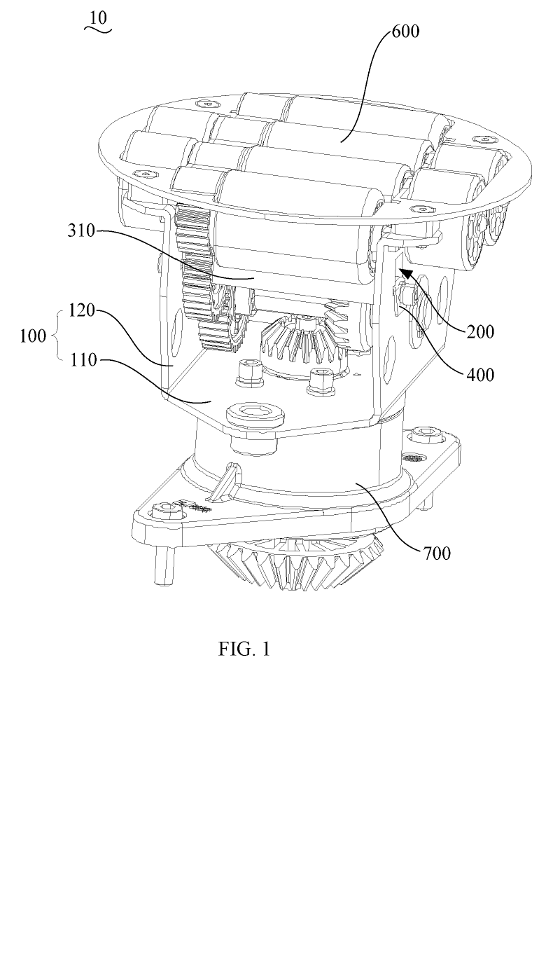

Referring to FIG. 1 to FIG. 8, in an embodiment of the present application, the sorting module 10 is used for a sorting device, and the sorting module 10 includes a sorting support 100, a mounting port 200, a transmission mechanism 300 and a limiting structure 400. The sorting support 100 includes a bottom plate 110 and two side plates 120 provided on opposite sides of the bottom plate 110. The mounting ports 200 are respectively provided at the two side plates 120, and the mounting ports 200 include a first mounting port 210 and a second mounting port 220 communicated with the first mounting port 210. The transmission mechanism 300 includes a shaft rod 310 mounted on the first mounting port 210, and the shaft rod 310 is fixed relative to the first mounting port 210. The first mounting port 210 is provided with a first direction for inserting the shaft rod 310, and the shaft rod 310 abuts against and limits the opposite side walls of the first mounting port 210 in a second direction. The limiting structure 400 is provided in the second mounting port 220 and configured to abut against and limit the shaft rod 310 in the first direction. The first direction crosses the second direction.

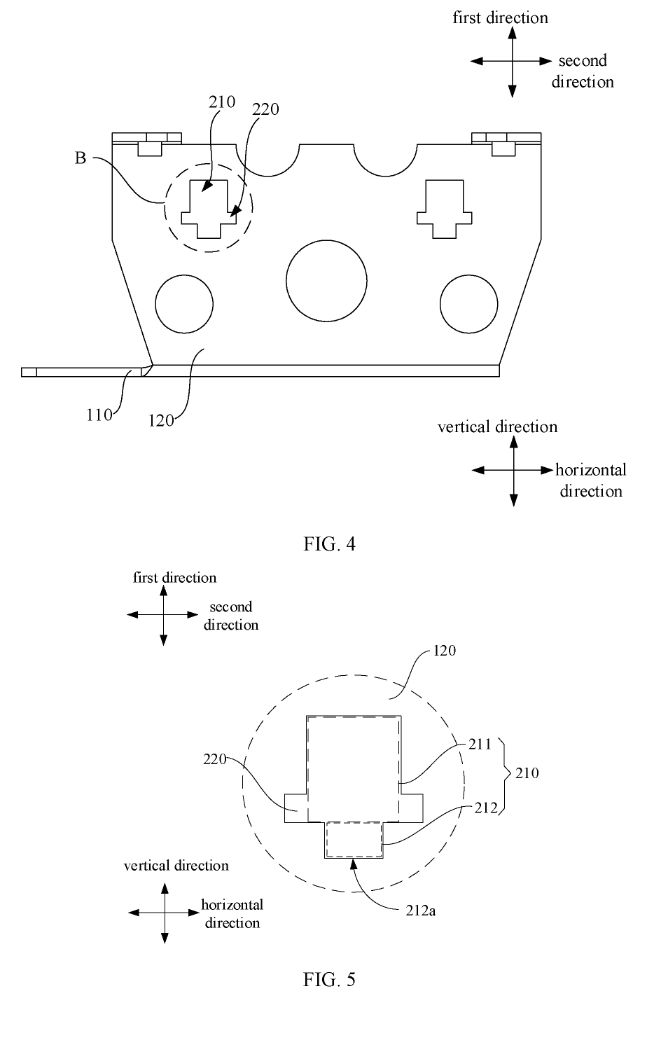

Referring to FIG. 4, the sorting support 100 includes a bottom plate 110 and two side plates 120 provided at opposite sides of the bottom plate 110, and a mounting space for mounting the transmission mechanism 300 of the sorting module 10 is formed between the two side plates 120. The side plates 120 and the bottom plate 110 are fixed together by screwing screws 500, and can also be connected together in other ways. In order to facilitate production and processing, the sorting support 100 of the present application is integrally molded, which is formed by one-time processing of sheet metal parts. The structure is simple and easy to process, which can further improve the production efficiency of the sorting support 100 while reducing production costs. At the same time, after the sorting support 100 of the present application is processed, no secondary processing is required, making its production process simpler and improving production efficiency. The material cost of the sorting support 100 made of sheet metal parts is relatively low, which further reduces costs.

Referring to FIG. 4 and FIG. 5, both side plates 120 are correspondingly provided with a first mounting port 210 and a second mounting port 220 communicated with the first mounting port 210. The shape of the first mounting port 210 and/or the second mounting port 220 may be an elongated port, an arc-shaped port, a port with a bent section, or a port of other shapes, and there is no specific restriction thereon. In order to facilitate manufacturing, the ports are typically configured with regular edges, such as a square or a circle. In this embodiment, both the first mounting port 210 and the second mounting port 220 are provided in a strip shape.

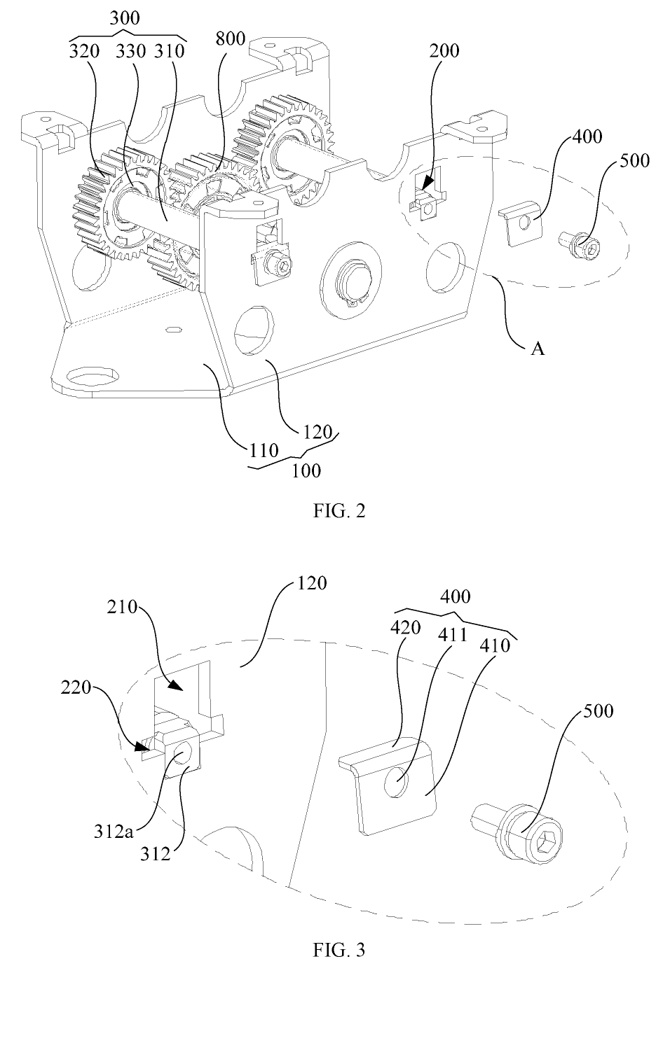

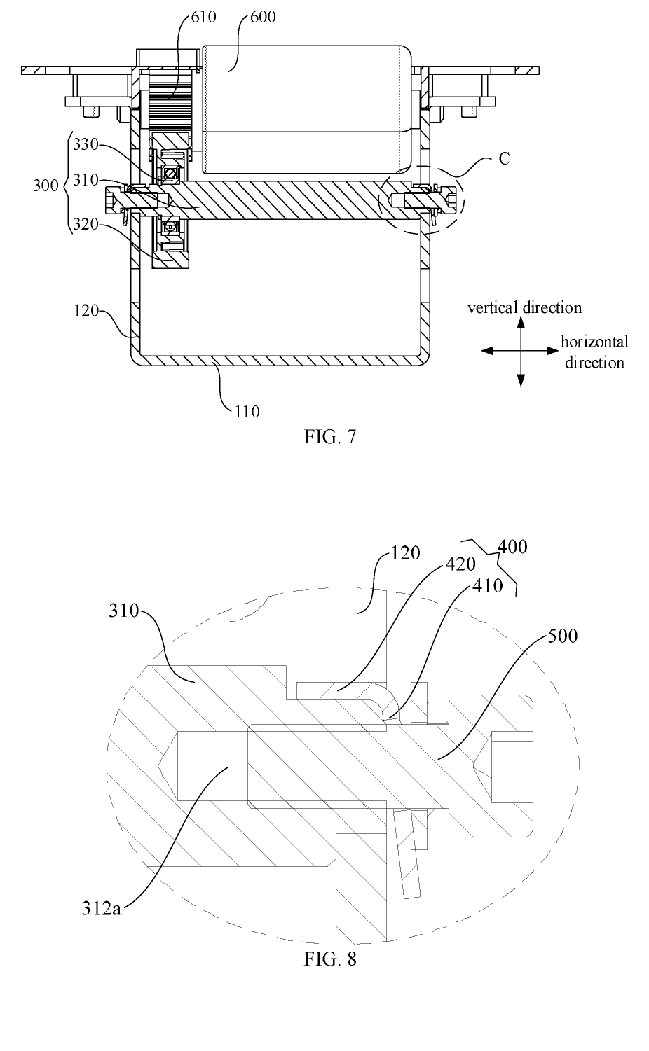

Referring to FIG. 2 and FIG. 7, the two ends of the shaft rod 310 are respectively mounted in the first mounting ports 210 of the two side plates 120, and the shaft rod 310 is fixed relative to the first mounting ports 210 and does not rotate by itself. During insertion of the shaft rod 310 into the first mounting ports 210, the direction in which the shaft rod 310 is inserted is defined as a first direction. After the shaft rod 310 is mounted in the first mounting port 210, at least a portion of the outer surface of the shaft rod 310 abuts against two opposing side walls of the first mounting port 210, so that the shaft rod 310 mounted in the first mounting port 210 is limited in the second direction.

At the same time, a limiting structure 400 is provided in the second mounting port 220, the limiting structure 400 abuts against the shaft rod 310, and the shaft rod 310 is also limited in the first direction by the limiting structure 400. Thus, through the cooperation between the shaft rod 310 and the two opposing side walls of the first mounting port 210, and the limiting action of the limiting structure 400, the position of the shaft rod 310 mounted in the mounting port 200 is restricted, preventing the shaft rod 310 from moving. In this way, the shaft rod 310 will be mounted in the preset position without deviation, ensuring the stability of the connection between the shaft rod 310 and the sorting support 100. Furthermore, when the transmission gears 320 sleeved on two adjacent shaft rods 310 are meshed, they mesh in the same plane, preventing abnormal meshing such as tooth misalignment or point meshing between gears, thereby ensuring the service life of the gears.

It should be noted that the first direction crosses the second direction, and the first direction can be a horizontal direction, a vertical direction, or an inclined direction, and there is no specific limitation on this.

The technical solution of the present application, by limiting the shaft rod 310 mounted in the first mounting port 210 in both the intersecting first direction and the second direction through two opposite side walls of the first mounting port 210 and the limiting structure 400, so as to fix the position of the shaft rod 310 mounted in the first mounting port 210, so that the shaft rod 310 will not be displaced relative to the sorting support 100, thereby ensuring the stability of the connection between the shaft rod 310 and the sorting support 100. This avoids the abnormal meshing situation of “trapezoidal meshing” that occurs when the transmission gears 320 mounted on two adjacent shaft rods 310 are meshed, i.e., the meshing gears are not on the same plane, thus ensuring the service life of the gears.

Referring to FIG. 2, FIG. 3 and FIG. 7 to FIG. 10, in an embodiment, the shaft rod 310 includes a main body portion 311 and a protrusion 312 protruding outward from both ends of the main body portion 311, and a first step surface 313 located on the end surface of the main body portion 311 is formed between the main body portion 311 and the protrusion 312. The protrusion 312 is provided in the first mounting port 210, and the first step surface 313 abuts against the inner wall surface of the side plate 120.

Referring to FIG. 10, the shaft rod 310 includes a rod-shaped main body portion 311 and a protrusion 312 protruding outward from the end surfaces at both ends of the main body portion 311 in the longitudinal direction. It should be noted that the protrusion 312 is formed by partially protruding outward from the center of the end face of the main body portion 311, and the midpoint of the protrusion 312 structure coincides with the axis of the main body portion 311. Since the protrusion 312 is formed by partially protruding outward from the center of the end face of the main body portion 311, the first step surface 313 is formed between the main body portion 311 and the protrusion 312. The first step surface 313 is the end surface of the main body portion 311 when the protrusion 312 is not protruding. The shape of the protrusion 312 can be provided in a more regular shape, so as to be better limited by the opposite side walls of the first mounting port 210.

In the radial direction of the shaft rod 310, the cross-section of the protrusion 312 is square. The square is roughly a square. For the convenience of processing and safety considerations, the four sides of the square are all chamfered. Of course, in other embodiments, the cross-sectional shape of the protrusion 312 can also be circular, triangular, trapezoidal or other shapes, and there is no specific restriction thereon.

Referring to FIG. 7 and FIG. 8, the first step surface 313 abuts against the inner wall of the side plate 120. This arrangement limits the axial direction of the shaft rod 310. At the same time, it prevents the sorting support 100 from deforming (i.e., the two side plates 120 of the sorting support 100 deform inward) caused by overtightening when connecting the shaft rod 310 to the sorting support 100 with screws 500. This would prevent misalignment of the gear teeth when meshing on the plurality of transmission shafts, resulting in a “trapezoidal meshing” situation where the meshing gears are not on the same plane, thus ensuring the service life of the gears.

The end surface of the protrusion 312 is aligned with the outer wall of the side plate 120. In an embodiment, if the end surface of the protrusion 312 is provided to protrude beyond the outer wall of the side plate 120, it is inconvenient to fix them, requiring a connecting member that matches the shape of the protrusion, which increases costs. However, if the end surface of the protrusion 312 is provided not to protrude beyond the outer wall of the side plate 120 and is not aligned with the outer wall of the side plate 120, the protrusion 312 may disengage from the mounting port 200 of the side plate 120, affecting the connection between the shaft rod 310 and the sorting support 100. In particular, when the side plate 120 is deformed outward, the protrusion 312 is more likely to disengage from the mounting port 200 of the side plate 120. Therefore, the end surface of the protrusion 312 is configured to be aligned with the outer wall of the side plate 120.

Referring to FIG. 4 and FIG. 5, in an embodiment, the first mounting port 210 includes an insertion port 211 and a limiting port 212 communicated with the insertion port 211. The insertion port 211 is configured to allow the protrusion 312 to be inserted into the limiting port 212, and the second mounting port 220 passes through the two opposite side walls of the insertion port 211.

When mounting the shaft rod 310, first, the two ends of the shaft rod are inserted into the insertion port 211, respectively. Then, the protrusion 312 is moved from the insertion port 211 to the limiting port 212 to limit the shaft rod 310 in the first direction. The second mounting port 220 passes through the two opposite side walls of the insertion port 211. The limiting structure 400 is placed in the second mounting port 220 to limit the shaft rod 310 in the second direction.

Referring to FIG. 4 and FIG. 5, in an embodiment, in the first direction, the height of the insertion port 211 is greater than the height of the limiting port 212. This arrangement facilitates the insertion of both ends of the shaft rod 310 into the insertion port 211, and provides sufficient space for the protrusion 312 to move into the limiting port 212 for limiting.

Referring to FIG. 4 and FIG. 5, in an embodiment, in a direction perpendicular to the first direction, the distance between the two side walls of the insertion port 211 is greater than the diameter of the shaft rod 310. Specifically, by setting the distance between the two side walls of the insertion port 211 to be greater than the diameter of the shaft rod 310, the shaft rod 310 can pass through the insertion port 211. When mounting the shaft rod 310, one end of the shaft rod 310 can be passed through the insertion port 211, and the other end can be moved downward into the insertion port 211 on the other side plate 120. Then, the protrusion 312 is moved from the insertion port 211 to the limiting port 212 for limiting, making installation convenient and quick.

Referring to FIG. 4 and FIG. 5, in an embodiment, the cross-sectional area of the insertion port 211 in the axial direction of the shaft rod 310 is 1 to 3 times the cross-sectional area of the limiting port 212. Specifically, by setting the cross-sectional area of the insertion port 211 in the axial direction of the shaft rod 310 to be 1 to 3 times the cross-sectional area of the limiting port 212, it is possible to ensure that the cross-sectional area of the insertion port 211 is sufficiently larger than the cross-sectional area of the limiting port 212, thereby facilitating mounting of the shaft rod 310 into the mounting port 200.

Referring to FIG. 4 and FIG. 5, in an embodiment, in the first direction, the height of the second mounting port 220 is less than the height of the limiting port 212. Specifically, the second mounting port 220 is primarily used for mounting a limiting structure 400 to limit the shaft rod 310 in the first direction. The limiting principle of the limiting structure 400 is that its two opposing surfaces abut against the protrusion 312 mounted in the limiting port 212 and the inner wall surface of the second mounting port 220, respectively, so that the protrusion 312 will not be displaced in the first direction, thereby limiting the shaft rod 310 in the first direction. By setting the height of the second mounting port 220 to be less than the height of the limiting port 212 allows for the use of a relatively thin (i.e., low-height) limiting structure 400 to achieve the limiting of the shaft rod 310, thus reducing the requirements for the limiting structure 400; it also ensures that a sufficient portion of the protrusion 312 is located in the limiting port 212, guaranteeing the limiting effect of the two opposing side walls of the limiting port 212 on the protrusion 312 in the second direction.

Referring to FIG. 4 and FIG. 5, in an embodiment, the second mounting port 220 extends along the second direction. In the second direction, the length of the second mounting port 220 is greater than the width of the insertion port 211 and the limiting port 212. Specifically, the second mounting port 220 can extend along the second direction. In the second direction, the second mounting port 220 passes through the side wall of the insertion port 211, ensuring that the length of the second mounting port 220 is sufficient so that the limiting structure 400 mounted in the second mounting port 220 can completely cover the protrusion 312 mounted in the limiting port 212, thereby limiting the shaft rod 310 in the first direction.

Referring to FIG. 5, FIG. 7 and FIG. 10, in an embodiment, a second step surface 314 is formed between the main body portion 311 and the protrusion 312, the first mounting port 210 is provided with a bottom wall 212a located downstream in the first direction, and the second step surface 314 is located on the side of the protrusion 312 away from the bottom wall 212a. The maximum distance between the second step surface 314 and the end surface of the protrusion 312 is greater than the maximum distance between the first step surface 313 and the end surface of the protrusion 312.

The main body portion 311 of the shaft rod 310 is a rod-shaped cylindrical body. The protrusion 312 extending outward from both ends of the protrusion 312 are generally square, thus forming a step surface between the protrusion 312 and the main body portion 311. The step surface can be roughly divided into four step surfaces corresponding to the four sides of the protrusion 312. The four step surfaces can be connected end to end to form a ring step surface, or they can be separated to form four independent step surfaces, or two or three adjacent step surfaces can be connected end to end, and there is no specific limitation on this. In this embodiment, the step surface can be specifically divided into a first step surface 313 and a second step surface 314, and the first step surface 313 abuts against the inner wall surface of the side plate 120 and mainly serves to limit the axial direction of the shaft rod 310. The maximum distance from the second step surface 314 to the end surface of the protrusion 312 is greater than the maximum distance from the first step surface 313 to the end surface of the protrusion 312, that is, the second step surface 314 is deep enough in the axial direction of the shaft rod 310, and the second step surface 314 is located on the side of the protrusion 312 away from the bottom wall 212a, that is, in the axial direction of the shaft rod 310, the projection of the second step surface 314 at least partially overlaps with the second mounting port 220, so that the limiting structure 400 mounted in the second mounting port 220 can extend into a sufficiently deep length, at least greater than the length of the protrusion 312, to ensure the limiting effect of the limiting structure 400 on the shaft rod 310 in the first direction.

Referring to FIG. 2 and FIG. 3, in an embodiment, the limiting structure 400 includes a connecting portion 410 and a limiting portion 420 connected to one end of the connecting portion 410. The limiting portion 420 extends into the second mounting port 220 and abuts against the outer wall surface of the protrusion 312 and the inner wall surface of the second mounting port 220, respectively. The connecting portion 410 is configured to connect with the protrusion 312. Specifically, the limiting structure 400 is roughly L-shaped, with a simple structure and easy manufacturing. The limiting structure 400 is divided into the limiting portion 420 inserted into the second mounting port 220 and the connecting portion 410 configured to be relatively fixed to the sorting support 100. The limiting structure 400 can be formed by bending a piece of sheet metal, which is easy to process. After the limiting portion 420 is inserted into the second mounting port 220, it abuts against the outer wall surface of the protrusion 312 and the inner wall surface of the second mounting port 220 respectively, so that the shaft rod 310 will not move relative to each other in the first direction, and the shaft rod 310 is abutted against and limited in the first direction.

Referring to FIG. 2, FIG. 3, FIG. 8 and FIG. 10, in an embodiment, a screw hole 312a is provided at the outer end surface of the protrusion 312, and the connection portion 410 is provided with a through hole 411 for a screw 500 to pass through. The screw 500 passes through the through hole 411 and is screwed into the screw hole 312a. Specifically, a through hole 411 can be directly provided in the connection portion 410 to allow the screw 500 to pass through and screw into the screw hole 312a in the protrusion 312 of the shaft rod 310 to fix the position of the limiting structure 400. This connection method is simple, and the screw 500 can be configured to relatively fix the limiting structure 400 to the sorting support 100 and the shaft rod 310, further ensuring that the shaft rod 310 will not move within the mounting port 200. In other embodiments, a hole may be provided in the sorting support 100 to secure the limiting structure 400 through the hole, thereby securing the limiting structure 400 relative to the sorting support 100 and ensuring that the limiting structure 400 effectively limits the position of the shaft rod 310. Alternatively, other connection methods may be configured to secure the limiting structure 400, without specific limitation.

Referring to FIG. 8, it is contemplated that if the length of the limiting portion 420 extending into the second mounting port 220 is insufficient, for example, if the length of the limiting portion 420 extending into the second mounting port 220 is less than the thickness of the side plate 120, the limiting portion 420 may easily disengage from the second mounting port 220 when the sorting module 10 is vibrated or the sorting support 100 is deformed. This would prevent the limiting portion 420 from effectively limiting the shaft rod 310 in the first direction, thus preventing the shaft rod 310 from moving in the first direction. Therefore, in order to solve this problem, the length of the limiting portion 420 extending into the second mounting port 220 is provided to be greater than the thickness of the side plate 120.

Referring to FIG. 3, FIG. 8 and FIG. 10, it should be noted that the end of the protrusion 312 is chamfered corresponding to the connection between the limiting portion 420 and the connecting portion 410. In an embodiment, the protrusion structure 400 is formed by bending a sheet metal member to form the limiting portion 420 and the connecting portion 410. Therefore, the connection between the connecting portion 410 and the limiting portion 420 forms an arc-shaped transition surface. In order to prevent the end of the protrusion 312 corresponding to the connection of the limiting portion 420 and the connecting portion 410 from interfering with the limiting structure 400, the end is chamfered to allow the protrusion structure 400 to fit against the outer surface of the protrusion 312.

In an embodiment, the angle formed by the first direction and the second direction is in the range of 45° to 135°. Specifically, the angle between the first direction and the second direction can be provided within the range of 45° to 135°. Within this range, it can be ensured that the shaft rod 310 mounted in the first mounting port 210 can be limited in both the first direction and the second direction. In this embodiment, the first direction is the extension direction of the first mounting port 210, and the second mounting port 220 is the extension direction of the second mounting port 220.

In an embodiment, the first direction is perpendicular to the second direction. That is, the extending direction of the first mounting port 210 is perpendicular to the extending direction of the second mounting port 220. The perpendicular arrangement of the first mounting port 210 and the second mounting port 220 facilitates processing, and the shaft rod 310 mounted in the first mounting port 210 can better cooperate with the protrusion 312 mounted in the first mounting port 210 to limit the shaft rod 310 in the first direction.

In an embodiment, the first mounting port 210 extends along a vertical direction, and the second mounting port 220 extends along a horizontal direction. The first mounting port 210 and the second mounting port 220, which extend along the vertical direction and the horizontal direction, are easy to process, and the shaft rod 310 mounted in the first mounting port 210 can be champed and limited by the limiting port 212 at the bottom of the first mounting port 210. At the same time, the first mounting port 210, which extends along the vertical direction, also facilitates the insertion of the shaft rod 310 into the first mounting port 210 for installation.

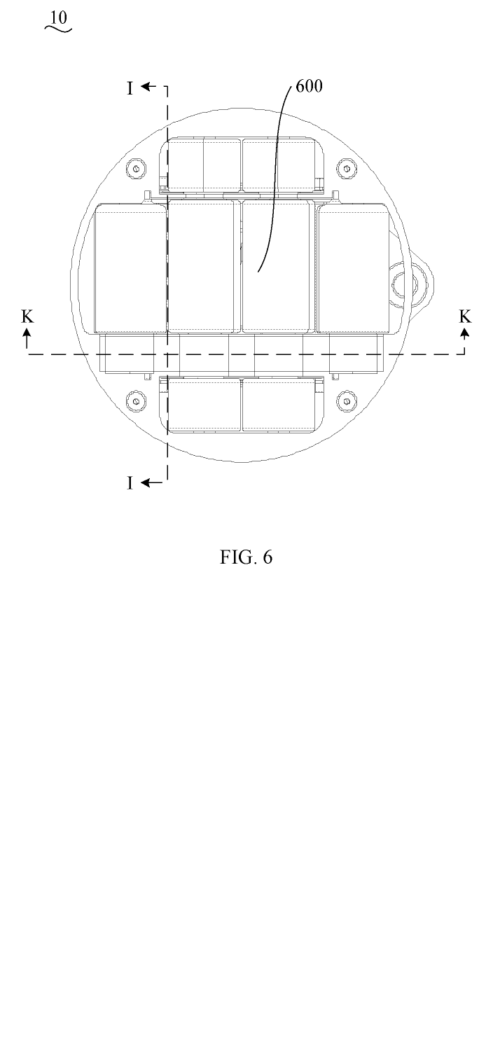

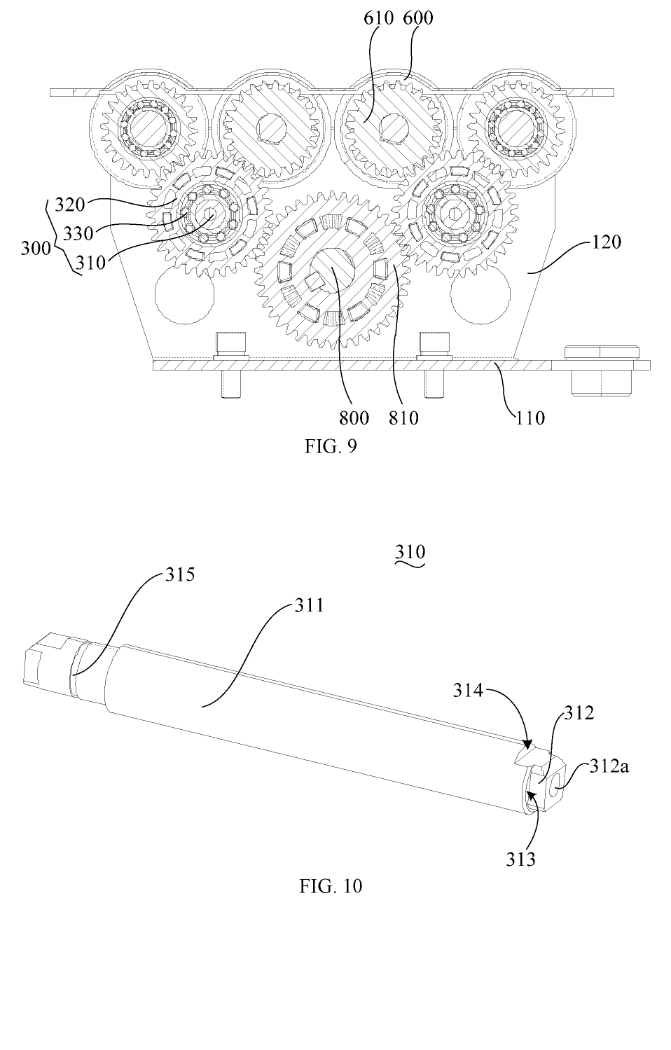

Referring to FIG. 1, FIG. 6 and FIG. 9, in an embodiment, the transmission mechanism 300 further includes a transmission gear 320, and the sorting module 10 further includes a roller group 600. The transmission gear 320 is rotatably provided at the shaft rod 310, and the roller group 600 is provided at the sorting support 100. The roller group 600 is provided with a roller gear 610, and the transmission gear 320 meshes with the roller gear 610.

The transmission gear 320 is rotatably sleeved on the shaft rod 310. A corresponding mounting position can be provided at the sorting support 100 for mounting the roller group 600. The roller gear 610 of the roller group 600 meshes with the transmission gear 320. Rotation of the transmission gear 320 drives the roller gear 610, thereby enabling the roller group 600 to rotate and transport goods passing through the roller group 600. The transmission gear 320 is provided at an end of the shaft rod 310. A blocking step and a ring clamping groove 315 can be provided at the shaft rod 310. The blocking step can limit one side of the transmission gear 320, and a clamping ring can be provided in the ring clamping groove 315 to limit the other side of the transmission gear 320.

Referring to FIG. 6, FIG. 7 and FIG. 9, in an embodiment, the transmission mechanism 300 also includes a bearing 330, and the bearing 330 includes a bearing inner ring, a bearing outer ring and a bearing ball located between the bearing inner ring and the bearing outer ring. The bearing inner ring is sleeved on the shaft rod 310 and fixed relative to the shaft rod 310, and the bearing outer ring is connected to the transmission gear 320.

The bearing inner ring is sleeved on the shaft rod 310 and fixed relative to the shaft rod 310, and the transmission gear 320 is sleeved on the outer ring of the bearing and fixed relative to the shaft rod 310. A driving mechanism 800 can be provided at one side of the transmission mechanism 300 to provide power for the transmission mechanism 300. The transmission gear 320 meshes with the driving gear 810 of the driving mechanism 800. When the driving gear 810 rotates, it drives the transmission gear 320 to rotate, thereby driving the roller gear 610 to rotate. The roller group 600 rotates on its own to transport the goods passing through the roller group 600.

Referring to FIG. 1, in an embodiment, the sorting module 10 further includes a base 700, and the sorting support 100 is rotatably mounted on the base 700. The base 700 is configured to be fixedly connected to the machine platform of the sorting device. Specifically, the sorting module 10 is fixedly mounted on the machine platform of the sorting device through the base 700, and the sorting support 100 is rotatable relative to the base 700. The roller group 600 is mounted on the sorting support 100 and is fixed relative to the sorting support 100. When the sorting support 100 rotates, it drives the roller group 600 to rotate, thereby controlling the transport direction of the goods passing through the roller group 600. Typically, the sorting device includes a plurality of sorting modules 10, the plurality of sorting modules 10 are provided in a plurality of rows and columns. A connecting hole is provided at the bottom plate 110 of the sorting support 100, and the connecting hole is configured to connect with a connecting rod. A row or column of sorting supports 100 can be connected by a connecting rod, so that the row of sorting supports 100 can rotate as a whole when the connecting rod moves. This connection method only requires a single motor to drive the connecting rod, reducing the number of motors used and significantly reducing costs. At the same time, this connection method is simple and easy to operate and mount, thereby improving production efficiency.

Referring to FIG. 1 to FIG. 10, the present application also provides a sorting module 10. In an embodiment of the present application, the sorting module 10 is used for a sorting device. The sorting module 10 includes a sorting support 100, a mounting port 200, a transmission mechanism 300, a limiting structure 400 and a roller group 600. The sorting support 100 includes a bottom plate 110 and two side plates 120 provided at opposite sides of the bottom plate 110. The mounting ports 200 are respectively provided at the two side plates 120, and the mounting ports 200 include a first mounting port 210 and a second mounting port 220 communicated with the first mounting port 210, the first mounting port 210 extends along the vertical direction, and the second mounting port 220 extends along the horizontal direction. The transmission mechanism 300 includes a shaft rod 310, a bearing 330 and a transmission gear 320, the bearing 330 is sleeved on the shaft rod 310, and the transmission gear 320 is sleeved on the bearing 330. The shaft rod 310 includes a main body portion 311 and a protrusion 312 formed by partially protruding outward from the middle portion of the end surfaces of both ends of the main body portion 311. The first mounting port 210 includes an insertion port 211 and a square limiting port 212 communicated with the insertion port 211, the square limiting port 212 is located below the insertion port 211, the insertion port 211 is configured to allow the protrusion 312 to be placed in the square limiting port 212, and the square limiting port 212 clamps and limits the protrusion 312 in the horizontal direction. A first step surface 313 is formed between the main body portion 311 and the protrusion 312, and the first step surface 313 abuts against the inner wall surface of the side plate 120. The limiting structure 400 is provided at the second mounting port 220 and configured to abut against and limit the shaft rod 310 in the vertical direction. The roller group 600 is provided at the sorting support 100, the roller group 600 is provided with a roller gear 610, and the transmission gear 320 meshes with the roller gear 610.

Referring to FIG. 4, the sorting support 100 includes a bottom plate 110 and two side plates 120 provided at opposite sides of the bottom plate 110. A mounting space for mounting the transmission mechanism 300 of the sorting module 10 is formed between the two side plates 120. The side plates 120 and the bottom plate 110 can be fixed together by screwing the screw 500, or they can be connected together by other means. In order to facilitate production and processing, the sorting support 100 of the present application is integrally molded, which is formed by one-time processing of sheet metal parts. The structure is simple and easy to process, which can further improve the production efficiency of the sorting support 100 and reduce production costs. At the same time, after the sorting support 100 of the present application is processed, it does not need to be processed twice. Its production and processing technology is simpler, which improves production efficiency. The material cost of the sorting support 100 made of sheet metal parts is relatively low, which further reduces costs.

Referring to FIG. 5, both side plates 120 are correspondingly provided a first mounting port 210 and a second mounting port 220 communicated with the first mounting port 210. The shape of the first mounting port 210 and/or the second mounting port 220 can be a long strip port, an arc port, a port with a bend section, or a port of other shapes, and there is no specific limitation on this. For ease of processing and manufacturing, the shape of the port is usually provided to a regular edge port, such as a square or a circle. In this embodiment, the first mounting port 210 and the second mounting port 220 are both provided in a long strip shape. The first mounting port 210 extends along the vertical direction, and the second mounting port 220 extends along the horizontal direction. The first mounting port 210 and the second mounting port 220, which extend along the vertical direction and the horizontal direction, are easy to process, and the shaft rod 310 mounted in the first mounting port 210 can be clamped and limited by the limit port 212 at the bottom of the first mounting port 210. At the same time, the first mounting port 210 extending in the vertical direction also facilitates the shaft rod 310 to extend into the first mounting port 210 so as to mount the shaft rod 310.

Referring to FIG. 7 to FIG. 10, the transmission mechanism 300 includes a shaft rod 310, a bearing 330, and a transmission gear 320, and the transmission gear 320 is rotatably sleeved on the shaft rod 310. A corresponding mounting position can be provided at the sorting support 100 for mounting the roller group 600. The roller gear 610 of the roller group 600 meshes with the transmission gear 320. Rotation of the transmission gear 320 drives the roller gear 610, thereby enabling the roller group 600 to rotate and transport goods passing through the roller group 600. The bearing 330 includes a bearing inner ring, a bearing outer ring, and a bearing ball located between the bearing inner ring and the bearing outer ring. The bearing inner ring is sleeved on the shaft rod 310 and fixed relative to the shaft rod 310. The transmission gear 320 is sleeved on the bearing outer ring and fixed relative to the bearing outer ring. A driving mechanism 800 can be provided at one side of the transmission mechanism 300 to provide power for the transmission mechanism 300. The transmission gear 320 meshes with the driving gear 810 of the driving mechanism 800. When the driving gear 810 rotates, it drives the transmission gear 320 to rotate, thereby driving the roller gear 610 to rotate, and the roller group 600 rotates on its own to transport the goods passing through the roller group 600.

Referring to FIG. 10, the shaft rod 310 includes a rod-shaped main body portion 311 and a protrusion 312 protruding outward from the end surfaces of the main body portion 311 along its length. It should be noted that the protrusions 312 are formed by partially protruding outward from the middle portion of the end surface of the main body portion 311, and the midpoint of the protrusion 312 structure coincides with the axis of the main body portion 311. Because the protrusions 312 are formed by partially protruding outward from the middle portion of the end surface of the main body portion 311, a first step surface 313 is provided between the main body portion 311 and the protrusion 312. The first step surface 313 corresponds to the end surface of the main body portion 311 when the protrusion 312 is not protruding. The protrusion 312 is inserted into the square limiting port 212, and the shaft rod 310 is limited in the horizontal direction through the cooperation between the protrusion 312 and the two side walls opposite to the square limiting port 212. The shaft rod 310 mounted in the first mounting port 210 is fixed relative to the first mounting port 210 and will not rotate by itself.

Referring to FIG. 7 and FIG. 8, the first step surface 313 abuts against the inner wall of the side plate 120. This arrangement limits the axial position of the shaft rod 310. At the same time, it can prevent the sorting support 100 from deforming (i.e., the two side plates 120 of the sorting support 100 deform inward) caused by overtightening when connecting the shaft rod 310 to the sorting support 100 with screws 500. This would cause misalignment of gear teeth when a plurality of gears on the drive shaft mesh, meaning the meshing gears are not on the same plane, that is, the meshing gears are not on the same plane, resulting in a “trapezoidal meshing” situation, thus ensuring the service life of the gears.

Referring to FIG. 2 and FIG. 3, a limiting structure 400 is also provided in the second mounting port 220. This limiting structure 400 abuts against the shaft rod 310, and the limiting structure 400 also limits the shaft rod 310 in the vertical direction. In this way, through the cooperation between the shaft rod 310 and the two opposing side walls of the first mounting port 210, and the limiting action of the limiting structure 400, the position of the shaft rod 310 mounted in the mounting port 200 is restricted, preventing the shaft rod 310 from moving. This ensures that the shaft rod 310 is mounted in the preset position without shifting, ensuring the stability of the connection between the shaft rod 310 and the sorting support 100. Furthermore, when two adjacent shaft rods 310 are mounted on the transmission gears 320, they mesh in the same plane, preventing abnormal meshing such as misalignment of gear teeth or point meshing between gears, thus ensuring the service life of the gears.

Referring to FIG. 2 to FIG. 5 and FIG. 8, in an embodiment, the second mounting port 220 passes through the two opposite side walls of the insertion port 211. In the vertical direction, the height of the insertion port 211 is greater than the height of the square limiting port 212, and the height of the second mounting port 220 is less than the height of the square limiting port 212. In the horizontal direction, the distance between the two side walls of the insertion port 211 is greater than the diameter of the shaft rod 310.

Referring to FIG. 5, the second mounting port 220 passes through two opposing side walls of the insertion port 211, and the limiting structure 400 is placed in the second mounting port 220 to limit the shaft rod 310 in the second direction. In the vertical direction, the height of the insertion port 211 is provided to be greater than the height of the square limiting port 212, and the height of the second mounting port 220 is provided to be less than the height of the square limiting port 212. This arrangement facilitates the insertion of both ends of the shaft rod 310 into the insertion port 211, and provides a certain amount of moving space for the protrusion 312 to move into the limiting port 212 for limiting. Furthermore, the shaft rod 310 can pass through the insertion port 211. When mounting the shaft rod 310, one end of the shaft rod 310 can be passed through the insertion port 211, and the other end of the shaft rod 310 can be moved downward into the insertion port 211 on the other side plate 120. The protrusion 312 can then be moved from the insertion port 211 to the limiting port 212 for limiting, making the installation quick and easy.

Referring to FIG. 8 to FIG. 10, in an embodiment, a second step surface 314 is further formed between the main body portion 311 and the protrusion 312, and the second step surface 314 is located on the side of the protrusion 312 away from the bottom of the first mounting port 210. The maximum distance from the second step surface 314 to the end surface of the protrusion 312 is greater than the maximum distance from the first step surface 313 to the end surface of the protrusion 312.

The main body portion 311 of the shaft rod 310 is a rod-shaped cylinder, and the protrusions 312 extending outward from both ends of the protrusion 312 are roughly square, thus forming a step surface between the protrusion 312 and the main body portion 311. The step surface can be roughly divided into four step surfaces corresponding to the four sides of the protrusion 312. The four step surfaces can be connected end to end in sequence to form a ring step surface, or they can be disconnected from each other to form four independent step surfaces, or two or three adjacent step surfaces can be connected end to end, and there is no specific limitation on this. In this embodiment, the above step surface can be specifically divided into a first step surface 313 and a second step surface 314. The first step surface 313 abuts against the inner wall surface of the side plate 120, mainly serving to limit the axial direction of the shaft rod 310. The maximum distance from the second step surface 314 to the end surface of the protrusion 312 is greater than the maximum distance from the first step surface 313 to the end surface of the protrusion 312, that is, the second step surface 314 is deep enough in the axial direction of the shaft rod 310. The second step surface 314 is located on the side of the protrusion 312 away from the bottom wall 212a, that is, in the axial direction of the shaft rod 310, the projection of the second step surface 314 at least partially overlaps with the second mounting port 220. This allows the limiting structure 400 mounted in the second mounting port 220 to extend to a sufficiently deep length, at least greater than the length of the protrusion 312, to ensure the limiting effect of the limiting structure 400 on the shaft rod 310 in the vertical direction.

Referring to FIG. 1 to FIG.3, in an embodiment, the limiting structure 400 includes a connecting portion 410 and a limiting portion 420 connected to one end of the connecting portion 410. The limiting portion 420 extends into the second mounting port 220 and abuts against the outer wall surface of the protrusion 312 and the inner wall surface of the second mounting port 220, respectively, and the connecting portion 410 is configured to connect with the protrusion 312. Referring to FIG. 7 to FIG.10, the length of the limiting portion 420 extending into the second mounting port 220 is greater than the thickness of the side plate 120. The end of the protrusion 312 is chamfered corresponding to the connection between the limiting portion 420 and the connecting portion 410, and the end surface of the protrusion 312 is aligned with the outer wall surface of the side plate 120.

In an embodiment, the limiting structure 400 is roughly L-shaped, featuring a simple structure and easy manufacturing. The limiting structure 400 includes a limiting portion 420 inserted into the second mounting port 220 and a connecting portion 410 fixed relative to the sorting support 100. The limiting structure 400 can be formed by bending a single sheet metal member, making it easy to manufacture. After the limiting portion 420 is inserted into the second mounting portion 220, it abuts against the outer wall of the protrusion 312 and the inner wall of the second mounting port 220, respectively, to prevent relative movement of the shaft rod 310 in the first direction, and the shaft rod 310 is abutted against and limited in the first direction.

It is considered that if the length of the limiting portion 420 extending into the second mounting port 220 is insufficient, for example, if the length of the limiting portion 420 extending into the second mounting port 220 is less than the thickness of the side plate 120, the limiting portion 420 may easily disengage from the second mounting port 220 when the sorting module 10 is subjected to vibration or the sorting support 100 is deformed, thereby failing to limit the shaft rod 310 in the first direction, allowing the shaft rod 310 to move in the first direction. In view of this, in order to solve this problem, the length of the limiting portion 420 extending into the second mounting port 220 is provided to be greater than the thickness of the side plate 120.

Referring to FIG. 3 and FIG. 8, the limiting structure 400 is formed by bending a sheet metal member to form the limiting portion 420 and the connecting portion 410. Therefore, the connection between the connecting portion 410 and the limiting portion 420 forms an arc-shaped transition surface. In order to prevent the end of the protrusion 312 corresponding to the connection of the limiting portion 420 and the connecting portion 410 from interfering with the limiting structure 400, the end is chamfered to allow the protrusion structure 400 to fit against the outer surface of the protrusion 312. At the same time, if the end surface of the protrusion 312 is provided to protrude beyond the outer wall surface of the side plate 120, it will be inconvenient to fix it, and a connecting member that adapts to the shape of the protrusion will be required, which increases the cost. If the end surface of the protrusion 312 is provided not to protrude beyond the outer wall surface of the side plate 120 and is not aligned with the outer wall surface of the side plate 120, the protrusion 312 may disengage from the mounting port 200 of the side plate 120, affecting the connection between the shaft rod 310 and the sorting support 100. In particular, when the side plate 120 is deformed outward, the protrusion 312 is more likely to disengage from the mounting port 200 of the side plate 120. Therefore, the end surface of the protrusion 312 is aligned with the outer wall surface of the side plate 120.

The present application also provides a sorting device, and the sorting device includes a platform assembly and a sorting module. A plurality of sorting modules are provided, and the plurality of sorting modules are provided in a plurality of rows and columns on the machine platform of the sorting device. The goods are transported by rotating the roller group on the sorting module, and the transportation direction of the goods is controlled by rotating the sorting module as a whole, so as to achieve the purpose of sorting the goods. The specific structure of the sorting module refers to the above embodiment. Since the sorting device adopts all the technical solutions of all the above embodiments, it has at least all the beneficial effects brought by the technical solutions of the above embodiments, which will not be repeated here.

The above description is merely an exemplary embodiment of the present application and does not limit the scope of the present application. Any equivalent structural modifications made using the contents of the specification and drawings of the present application under the technical concept of the present application, or any direct or indirect application in other related technical fields, are included within the scope of the present application.

What is claimed is:

1. A sorting module for a sorting device, comprising:
a sorting support comprising a bottom plate and two side plates provided at opposite sides of the bottom plate;
a mounting port respectively provided at the two side plates, wherein the mounting port comprises a first mounting port and a second mounting port communicated with the first mounting port;
a transmission mechanism comprising a shaft rod mounted on the first mounting port, wherein the shaft rod is fixed relative to the first mounting port, the first mounting port is provided with a first direction for inserting the shaft rod, and the shaft rod abuts against and limits opposite side walls of the first mounting port in a second direction; and
a limiting structure provided in the second mounting port and configured to abut against and limit the shaft rod in the first direction;
wherein the first direction crosses the second direction.

2. The sorting module according to claim 1, wherein:
the shaft rod comprises a main body portion and a protrusion protruding outward from two ends of the main body portion, and a first step surface located on an end surface of the main body portion is formed between the main body portion and the protrusion; and
the protrusion is provided at the first mounting port, and the first step surface abuts against an inner wall surface of the side plate.

3. The sorting module according to claim 2, wherein the first mounting port comprises an insertion port and a limiting port communicated with the insertion port, the insertion port is configured to allow the protrusion to be inserted into the limiting port, and the second mounting port passes through two opposite side walls of the insertion port.

4. The sorting module according to claim 3, wherein in the first direction, a height of the insertion port is greater than a height of the limiting port.

5. The sorting module according to claim 3, wherein in a direction perpendicular to the first direction, a distance between two side walls of the insertion port is greater than a diameter of the shaft rod.

6. The sorting module according to claim 3, wherein in an axial direction of the shaft rod, a cross-sectional area of the insertion port is 1 to 3 times a cross-sectional area of the limiting port.

7. The sorting module according to claim 3, wherein in the first direction, a height of the second mounting port is smaller than a height of the limiting port.

8. The sorting module according to claim 3, wherein the second mounting port extends along the second direction, and in the second direction, a length of the second mounting port is greater than a width of the insertion port and a width of the limiting port.

9. The sorting module according to claim 2, wherein:
a second step surface is further formed between the main body portion and the protrusion, the first mounting port is provided with a bottom wall downstream in the first direction, and the second step surface is located on a side of the protrusion away from the bottom wall; and
a maximum distance from the second step surface to an end surface of the protrusion is greater than a maximum distance from the first step surface to the end surface of the protrusion.

10. The sorting module according to claim 9, wherein the limiting structure comprises a connecting portion and a limiting portion connected to an end of the connecting portion, the limiting portion extends into the second mounting port and abuts against an outer wall surface of the protrusion and an inner wall surface of the second mounting port, respectively, and the connecting portion is configured to connect with the protrusion.

11. The sorting module according to claim 10, wherein the outer end surface of the protrusion is provided with a screw hole, the connecting portion is provided with a through hole for the screw to pass through, and the screw passes through the through hole and is screwed into the screw hole.

12. The sorting module according to claim 10, wherein a length of the limiting portion extending into the second mounting port is greater than a thickness of the side plate.

13. The sorting module according to claim 10, wherein an end portion of the protrusion is chamfered corresponding to a connection between the limiting portion and the connecting portion.

14. The sorting module according to claim 1, wherein an angle formed by the first direction and the second direction is in a range of 45° to 135°.

15. The sorting module according to claim 1, wherein:
the transmission mechanism further comprises a transmission gear, the sorting module further comprises a roller group, and the transmission gear is rotatably provided at the shaft rod; and
the roller group is provided at the sorting support, the roller group is provided with a roller gear, and the transmission gear meshes with the roller gear.

16. The sorting module according to claim 15, wherein:
the transmission mechanism further comprises a bearing, and the bearing comprises a bearing inner ring, a bearing outer ring, and a bearing ball located between the bearing inner ring and the bearing outer ring; and
the bearing inner ring is sleeved on the shaft rod and fixed relative to the shaft rod, and the bearing outer ring is connected to the transmission gear.

17. The sorting module according to claim 1, further comprising a base;
wherein the sorting support is rotatably mounted on the base, and the base is configured to be fixedly connected to a machine platform of the sorting device.

18. A sorting module for a sorting device, comprising:
a sorting support comprising a bottom plate and two side plates provided at opposite sides of the bottom plate;
a mounting port provided at the two side plates, wherein the mounting ports comprises a first mounting port and a second mounting port communicated with the first mounting port, the first mounting port extends along a vertical direction, and the second mounting port extends along a horizontal direction;
a transmission mechanism comprising a shaft rod, a bearing and a transmission gear, wherein the bearing is sleeved on the shaft rod, and the transmission gear is sleeved on the bearing; the shaft rod comprises a main body portion and a protrusion formed by partially protruding outward from the middle portion of the end surfaces of both ends of the main body portion; the first mounting port comprises an insertion port and a square limiting port communicated with the insertion port, the square limiting port is located below the insertion port, the insertion port is configured to allow the protrusion to be inserted into the square limiting port, and the square limiting port clamps and limits the protrusion in a horizontal direction; a first step surface is formed between the main body portion and the protrusion on an end surface of the main body portion, and the first step surface abuts against an inner wall surface of the side plate;
a limiting structure provided at the second mounting port and configured to abut against and limit a position of the shaft rod in the vertical direction; and
a roller group provided at the sorting support, wherein the roller group is provided with a roller gear, and the transmission gear meshes with the roller gear.

19. A sorting device, comprising the sorting module according to claim 1.

20. A sorting device, comprising the sorting module according to claim 18.
